(19) United States
(12) Patent Application Publication
(10) Pub. No.: US 2007/0265876 A1
(43) Pub. Date: Nov. 15, 2007

(54) Systems and methods for providing a network using postal routed node topology

(75) Inventor: Leo J. Campbell, Arlington, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: United States Postal Service

(21) Appl. No.: 11/812,321

(22) Filed: Jun. 18, 2007

Related U.S. Application Data
(62) Division of application No. 10/362,090, filed on Feb. 21, 2003.

(51) Int. Cl. G06Q 90/00

(52) U.S. Cl. 705/1

(57) ABSTRACT

The specification describes a system and method for providing a network using postal routed node topology. The system provides links between databases, General Mail Facilities, Post Offices, and letter carriers. This allows for individuals to receive up to date information regarding mail delivery. It also allows users to communicate directly with the Post Office regarding their mail delivery.

### CROSS REFERENCE TO RELATED APPLICATION

This application claims the benefit of U.S. Provisional Application No. 60/231,336, filed Sep. 8, 2000 by Leo J. Campbell and titled SYSTEMS AND METHOD FOR PROVIDING A NETWORK USING POSTAL ROUTED INTERNET NODE TOPOLOGY, the disclosure of which is expressly incorporated herein by reference.

### DESCRIPTION OF THE INVENTION

1. Background of the Invention

Currently, mail delivery systems provide limited access to real-time information regarding the delivery status of mail pieces. Typically, delivery information is only available hours after delivery of the mail piece has occurred. Further, this information is only available for particular mail pieces. In addition, these systems have a limited capability for senders and recipients to instruct letter carriers to redirect or alter the delivery of a mail piece.

For example, in one current system, the United States Postal Service (“USPS”) equips each letter carrier with a bar code reader. Certain mail pieces contain bar codes that provide information about the mail piece, such as the intended recipient. Upon delivery of a mail piece, the letter carrier uses the reader to scan the bar code on the mail piece. The device then records the delivery information for that particular mail piece. However, letter carriers do not immediately upload this information to a database accessible by delivery customers. Rather, this information is not uploaded to an accessible database until the letter carrier returns to a Post Office. In another current system, the USPS also equips the letter carrier with a signature capture device. In this case, the letter carrier records not only the delivery information regarding a mail piece, but the signature of the recipient of the mail piece.

Both of these systems, however, only work for particular mail pieces designated with a bar code. Typically, these are only Priority Mail or Express Mail pieces. Therefore, a large amount of mail is not tracked by these systems. Further, these systems do not allow for real-time information because the letter carrier only updates the information database upon returning to the Post Office. Finally, these systems do not provide any method of notifying a letter carrier in real time regarding the redirection of any mail pieces.

### SUMMARY OF THE INVENTION

One embodiment of the invention is directed towards a communications network system for mail delivery. The system includes at least one central database for storing mail delivery information. The system also includes a plurality of interconnected general network servers, a plurality of regional network servers, and a plurality of mobile communications devices. Each general network servers is linked to the central database. Further, each general network server is located in one of a plurality of general mail facilities. These general mail facilities are geographically dispersed throughout an area served by the communications network. Each regional network servers is linked to at least one general network server and is located in one of a plurality of regional mail facilities. Each regional mail facility corresponds to a discrete section of the area served by the general mail facilities. Each mobile communications device is located in one of a plurality of mobile Units corresponding to each regional mail facility. Further, each mobile communications device is linked to a regional network server in a corresponding regional mail facility. The system also includes means for determining mail piece information for a mail piece and means for creating electronic postmarks to be transmitted over the communications network system to the central database. Each electronic postmark includes the mail piece information for the mail piece.

In another embodiment, the means for determining mail piece information includes a scanner for determining the delivery location and origin of the mail piece located in each mobile communications device. Further, each mobile communications device includes a wireless transmitter to transmit at least periodically electronic postmarks to the corresponding regional network server.

In a further embodiment, the system also comprises a plurality of personal communications devices. Each personal communications device is located at a letter carrier and is linked to a mobile communications device in a corresponding mobile unit. In one embodiment, the means for determining mail piece information includes a scanner for determining the delivery location and origin of the mail piece located in each personal communications device. Further, each personal communications device includes a wireless transmitter to transmit, at least periodically, electronic postmarks to the corresponding mobile unit. Finally, each mobile communications device includes a wireless transmitter to continuously transmit information to the corresponding regional network server. In a further embodiment, the scanner also includes an optical character reader.

In another embodiment of the system, the plurality of general mail facilities are United States Postal Service General Mail Facilities, the plurality of regional mail facilities are United States Post Offices, the plurality of mobile units are United States Postal Service mail delivery vehicles, and the letter carriers are United States Postal Service letter carriers.

The invention is also directed to a method for providing continuous delivery information for a mail piece in a mail delivery system. In this embodiment, the intended delivery location of the mail piece is determined when the mail piece is first picked up by a letter carrier. An electronic postmark is then created, wherein the electronic postmark includes the intended delivery location of the mail piece. Next, the electronic postmark is transmitted to a regional network server located in one of a plurality of regional mail facilities. Then, the electronic postmark is transmitted from the regional network server to a general network server located in one of a plurality of general mail facilities. Finally, the electronic postmark is transmitted from the general network server to one of a plurality of central databases. In this method, the general mail facilities are geographically dispersed throughout an area served by the communications network and each regional mail facility corresponds to discrete sections of the area served by the general mail facilities.

In another embodiment of the method, the origin of the mail piece is also determined when the mail piece is first picked up by a letter carrier. In this embodiment, the electronic postmark also includes the origin of the mail piece. In another embodiment, the step of transmitting the electronic postmark to the regional network server occurs in substantially real-time.

In another embodiment, the intended delivery location of a mail piece is determined when the mail piece is first picked up by a letter carrier. An electronic postmark is then created, wherein the electronic postmark includes the intended delivery location of the mail piece. Then, the electronic postmark is transmitted to a mobile communications device located in one or more mobile units. Next, the electronic postmark is transmitted from the mobile communications device to a regional network server located in one of a plurality of regional mail facilities. Then, the electronic postmark is transmitted from the regional network-server to a general network server located in one of a plurality of general mail facilities. Finally, the electronic postmark is transmitted from the general network server to one of a plurality of central databases. In this embodiment, the general mail facilities are geographically dispersed throughout an area served by the communications network, each regional mail facility corresponds to discrete sections of the area served by the general mail facilities, and each mobile unit corresponds to a regional mail facility.

In another embodiment of this method, the origin of the mail piece is also determined when the mail piece is first picked up by a letter carrier. In this embodiment, the electronic postmark also includes the origin of the mail piece. In one embodiment of this method, the steps of transmitting the electronic postmark to the mobile communications device and transmitting the electronic postmark from the mobile communications device to the regional network server occur in substantially real-time.

In another embodiment of this method, the plurality of general mail facilities are United States Postal Service General Mail Facilities, the plurality of regional mail facilities are United States Post Offices, and the one or more mobile units are United States Postal Service mail delivery vehicles.

In an embodiment of this method, the intended delivery location of the mail piece, the origin of the mail piece, and the current location of the mail piece are determined when the mail piece arrives at the regional mail facility. Then, a second electronic postmark is created, wherein the second electronic postmark includes the intended delivery location of the mail piece, the origin of the mail piece, and the current location of the mail piece determined when the mail piece arrived at the regional mail facility. Next, the second electronic postmark is transmitted from the regional network server to the general network server. Finally, the second electronic postmark is transmitted from the general network server to one of the plurality of central databases.

In another embodiment of this method, the intended delivery location of the mail piece, the origin of the mail piece, and the current location of the mail piece is determined when the mail piece arrives at the general mail facility. Next, a third electronic postmark is created, wherein the third electronic postmark includes the intended delivery location of the mail piece, the origin of the mail piece, and the current location of the mail piece determined when the mail piece arrived at the general mail facility. Finally, the third electronic postmark is transmitted from the general network server to one of the plurality of central databases.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWING

FIG. 1 illustrates the geographical subdivisions of United States Postal Service mail facilities.

FIG. 2 illustrates a portion of one embodiment of the system of the invention.

FIG. 3 illustrates another portion of one embodiment of the system of the invention.

FIG. 4 illustrates another portion of one embodiment of the system of the invention.

FIG. 5 illustrates one embodiment of the system of the invention.

### DESCRIPTION OF THE EMBODIMENTS

Reference will now be made in detail to one embodiment consistent with the invention, an example of which is illustrated in the accompanying drawings.

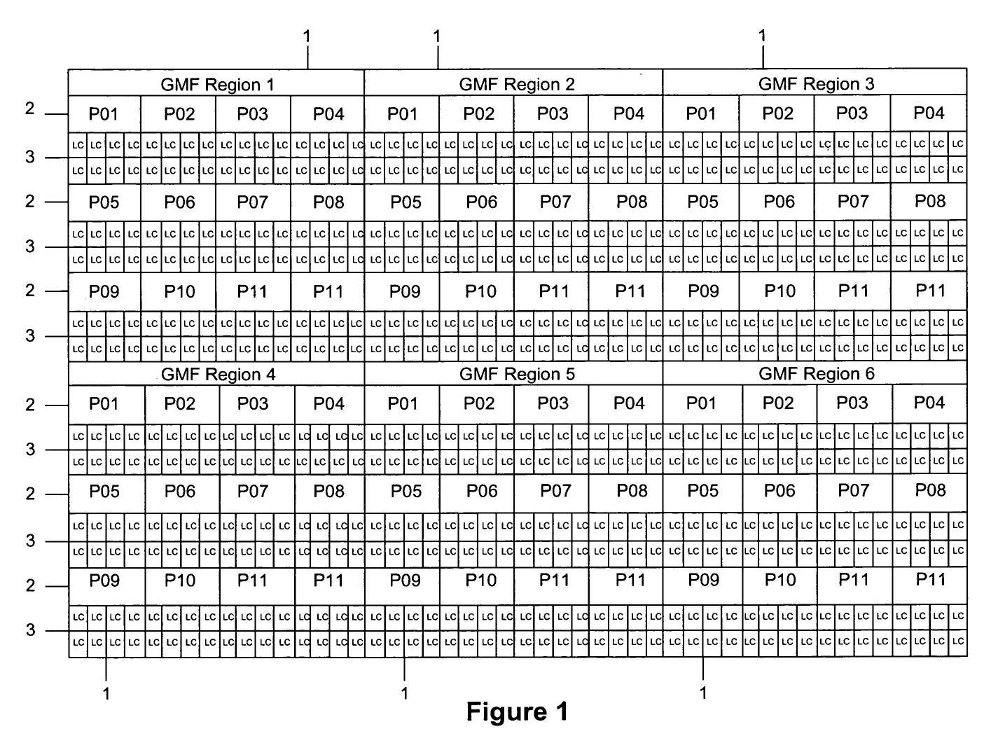

This embodiment is directed to a method for providing a communications network using a postal routed node topology. FIG. 1 illustrates the geographical subdivisions of USPS mail facilities. In general, the USPS divides mail delivery within the United States among several regions. Each region contains a General Mail Facility 1 to regulate the mail delivery for that region. Within each region, the USPS operates a number of Post Offices 2, which are responsible for a portion of that region. In turn, each Post Office 2 utilizes a number of letter carriers 3 who are responsible for a part of that Post Office's area. Typically, each letter carrier is assigned to a mail vehicle.

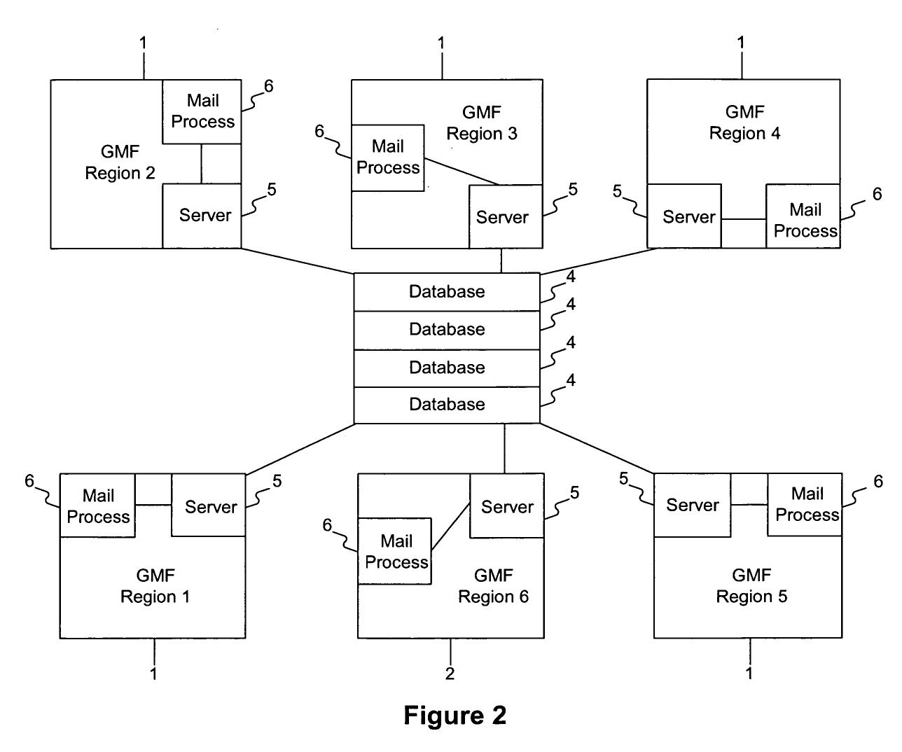

As seen in FIG. 2, the system contains a series of central databases 4 to maintain mail delivery information for the system. Databases 4 can be any of a number of well-known database systems suitable for storing electronic data. Although four databases are depicted in FIG. 2, any number may be used consistent with the present invention. Databases 4 are electronically linked with a server 5 located at General Mail Facilities 1. Again, although six general mail facilities 1 are shown, any number may be connected to the database. This link can be through wireless or wired connections, such as a local area network.

Each General Mail Facility 1 also contains mail processing equipment 6 to sort mail pieces for delivery and gather delivery information regarding each mail piece. This information could include the intended delivery location, the origin of the mail piece, its current location (i.e. the General Mail Facility 1), and its anticipated delivery date. Mail processing equipment 6 generates a hash file based on this information and stores the hash file in an electronic postmark (“EPM”).

An EPM is a time-stamped and cryptographically sealed digital hash file. The EPM includes a time and date stamp indicating when the EPM was generated. The contents of an EPM are digitally “sealed” by the addition of a digital signature. An exemplary EPM is described in U.S. Ser. No. 09/675,677 filed Sep. 29, 2000, by Leo J. Campbell et al. and titled “Systems and Methods for Authenticating an Electronic Message,” the disclosure of which is expressly incorporated herein by reference to its entirety.

Mail processing equipment 6 may generate the hash file using known hashing techniques, such as a Secure Hash Algorithm (“SHA-1”), a technique based on an algorithm provided by Rivest, Shamir, and Adelman (“RSA”), or a Message Digest Algorithm (“MD5”). After storing the information in an EPM, mail processing equipment 6 sends the EPM to server 5. Server 5 then sends the EPM to central database 4.

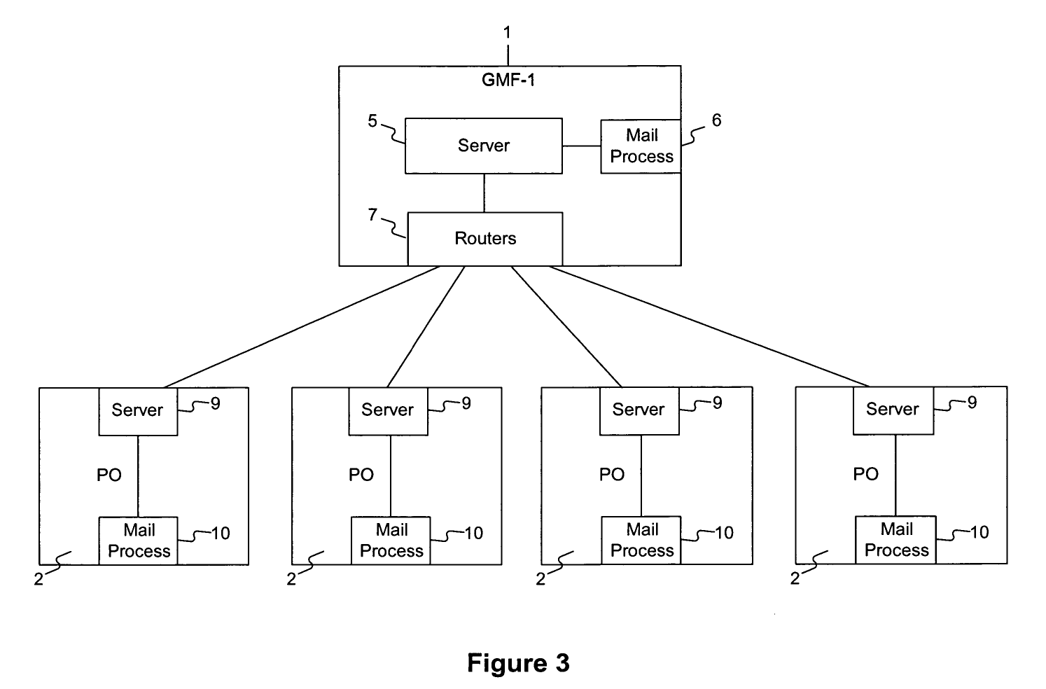

As shown in FIG. 3, in this embodiment, each General Mail Facility 1 has a series of routers 7 to link server 5 at General Mail Facility 1 with a server 9 at each Post Office 2 in its region. Although four Post Offices 2 are shown, any number of Post Offices could be connected to a General Mail Facility 1. Routers 7 are of the type well known in the art to route communications between various servers. The link between Post Office servers 9 and General Mail Facility router 7 could be, for example, wireless, Internet wireless, Internet landline, or fiber optic cable.

Each Post Office 2 has mail processing equipment 10 that is linked with Post Office server 9. Mail processing equipment 10 stores the information regarding each mail piece in an EPM along with the date and time the information was gathered as described above. Mail processing equipment 10 sends this EPM to server 9. In turn, server 9 sends the EPM to router 7. Finally, router 7 sends the EPM to server 5, which sends the EPM to central database 4.

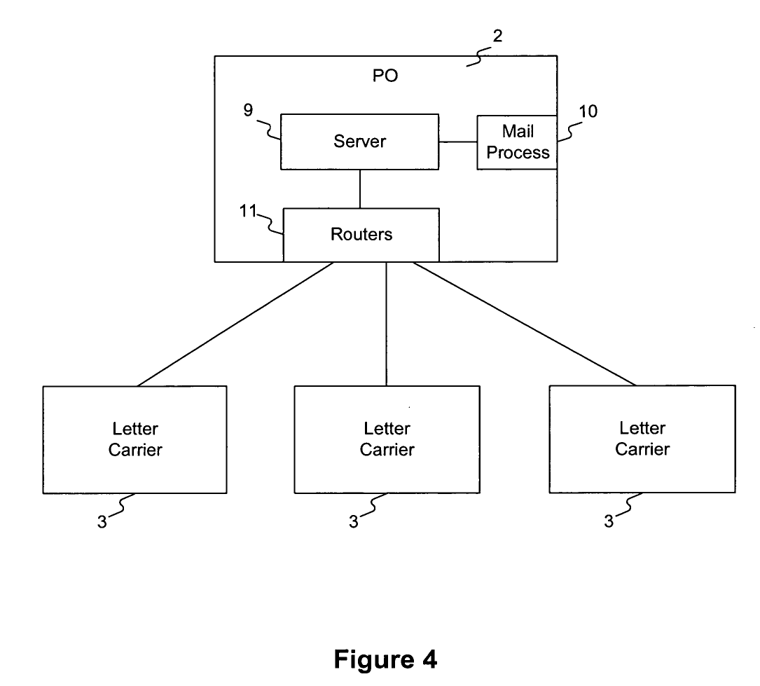

As shown in FIG. 4, each server 9 at Post Office 2 is also connected to several routers 11 contained at Post Office 2. Routers 11 are linked to letter carriers 3 that work out of each Post Office. Any number of carriers may be connected to these routers.

Routers 11 and letter carriers 3 are linked using one of several methods. In one method, Post Office server 9 is linked by radio signals to a mobile communications device contained in each letter carrier's mail vehicle. In this method, the mobile communications device consists of a device for transmitting data to Post Office 2, a device to read information about each incoming mail piece, and a mobile computer to operate the reading device, to store the mail piece information, and to transmit the information to Post Office 2. Again, the mail piece information is stored in an EPM along with the date and time at which the mail piece was stored. The EPM is sent to router 11, which sends it to server 9. Server 9 sends the EPM to router 7, which sends it to server 5. Server 5 then sends the EPM to central database 4.

The transmitting device would be wireless and could utilize industry standard protocols such as 802.11B. The reading device could be a scanner capable of scanning only those mail pieces containing bar codes. Preferably, the device would use an optical character reader or similar technology to determine delivery information for all mail pieces. Further, the reading device would contain a method for tracking the origin of the mail piece. This could be achieved by scanning for a return address. This could also be achieved through the use of a Global Positioning System. At each stop, the device would record its exact position as mail from that location is fed through the scanner. Thus, a record of the origin of each piece of mail would be maintained. The mobile computer is any device capable of operating the reading device, storing the mail piece information, and transmitting that information.

In another method, router 11 is linked directly to each letter carrier 3 via a handheld device. The handheld device would be capable of reading information from a piece of mail, storing that information in an EPM, and transmitting that information to Post Office 2. The handheld device could use any of the methods described above to read information about the mail piece. Further, letter carrier 3 could enter in the origin of the mail piece into the device or the device could use a GPS system as described above. The device transmits the EPM using any of the methods described above.

While either of these methods could be used, the use of a mobile communications device in a mail vehicle would allow for the storage of a greater amount of information than could be stored in a handheld device because the mail vehicle could meet the power requirements needed to store larger amounts of information.

In a third method, router 11 is again linked to a mobile communications device contained in each letter carrier's vehicle as described above. In addition, the device contained in each vehicle would be linked with a handheld device carried by letter carrier 3 as described above. In this embodiment, letter carrier 3 uses the handheld device to store information for mail pieces in an EPM while out of the vehicle. The EPM would then be sent to the mail vehicle device. The handheld device could transmit the EPM using one of the methods described above or other industry adopted technology such as blue tooth. This EPM would then be sent to Post Office 2 by the mail vehicle device.

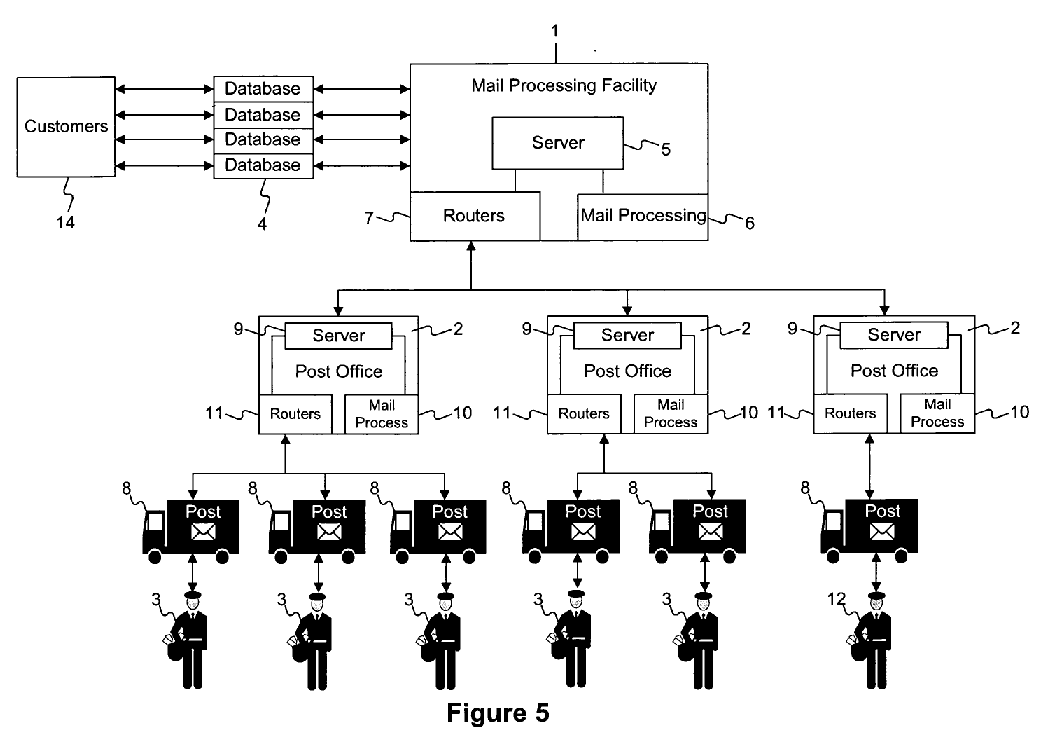

FIG. 5 illustrates one embodiment of the system for one General Mail Facility consistent with the invention. In the embodiment, server 5 contained at the General Mail Facility 1 is connected to databases 4. Server 5 is connected to mail processing equipment 6 and routers 7. Routers 7 are connected to servers 9 at Post Offices 2 under the General Mail Facility 1. Servers 9 are connected to routers 11 and mail processing equipment 10. contained at Post Office 2. In turn, Post Office routers 11 are connected with mail vehicles 8. Each mail vehicle is connected to each mail carrier 3 through a handheld device.

This system allows for a constant stream of real-time information regarding mail delivery to the central databases. For example, in the embodiment in FIG. 5, when letter carrier 3 picks up a piece of mail, he or she will immediately use a handheld device to scan the delivery information for that piece of mail. The device could be capable of scanning only those mail pieces containing bar codes, but preferably, the device would be capable of determining delivery information for all mail pieces. This could be done using an optical character reader or similar device to retrieve information about the mail piece.

This information is stored in a first EPM and transmitted in substantially real time to mail vehicle 8. From mail vehicle 8, it is sent to Post Office 2, General Mail Facility 1, and finally to databases 4 as described above. When the mail piece reaches Post Office 2, it will again be scanned during processing and a second EPM will be generated. This second EPM will be sent to the database 4. The database 4 will then update the first EPM with the information contained in the second EPM. Depending on the destination of the mail piece, it would then be sent to a General Mail Facility 1 or to another Post Office 2 where it would again be scanned during processing to update databases 4. Finally, upon delivery, the delivery information would also be sent immediately to databases 4. Thus, the databases 4 would have accurate updated information at all times.

As shown in FIG. 5, both the mail service customers 14 and the USPS itself would have access to this information contained in these central databases. Customer 14 could access information through web browsers, e-mail, or other Internet devices. Further, pagers, cell phones, or even regular phone lines could be used to access the database. This would allow customers 14 to track all of their mail, both incoming and outgoing, at all times.

As shown in FIG. 5, this system also allows customers 14 to provide instructions to USPS regarding their mail delivery. Using the same connections described above, customer 14 would be able to send information regarding their mail to USPS. For example, a sender could notify USPS that it will be shipping large amounts of mail on certain days of the week. In addition, recipients could instruct the USPS to redirect mail pieces. For example, if an individual were out of town, that individual (using the Internet) could access data recording the mail scheduled for delivery to them on a given day. If one mail piece were particularly important, they could instruct USPS to redirect that mail piece to their current location. All of the communications could be encrypted to provide customers with privacy regarding their mail.

Finally, by having all General Mail Facilities 1 in the United States connected to central databases 4, USPS local area managers are able to manage their staffing resources more efficiently. Continuously updated databases allow these managers to determine the amount of mail headed for their facility and the amount of mail to be delivered at any point in time. This allows managers to make realistic estimates regarding the necessary workforce. Further, if senders can notify mailers in advance of large mailings, the local manager can schedule his resources to match the amount of mail that needs to be processed.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-6. (canceled)

7. A method for providing continuous delivery information for a mail piece in a mail delivery system comprising the steps of:
determining the intended delivery location of a mail piece when the mail piece is first picked up by a letter carrier;
creating an electronic postmark, wherein the electronic postmark includes the intended delivery location of the mail piece;
transmitting the electronic postmark to a regional network server located in one of a plurality of regional mail facilities;
transmitting the electronic postmark from the regional network server to a general network server located in one of a plurality of general mail facilities; and
transmitting the electronic postmark from the general network server to one of a plurality of central databases;
wherein the general mail facilities are geographically dispersed throughout an area served by the communications network and each regional mail facility corresponds to discrete sections of the area served by the general mail facilities.

8. The method of claim 7, further comprising the step of
determining the origin of the mail piece when the mail piece is first picked up by a letter carrier and
wherein the electronic postmark includes the origin of the mail piece.

9. The method of claim 8, wherein the step of transmitting the electronic postmark to the regional network server occurs in substantially real-time.

10. A method for providing continuously updated mail delivery information comprising the steps of:
determining the intended delivery location of a mail piece when the mail piece is first picked up by a letter carrier;
creating an electronic postmark, wherein the electronic postmark includes the intended delivery location of the mail piece;
transmitting the electronic postmark to a mobile communications device located in one or more mobile units;
transmitting the electronic postmark from the mobile communications device to a regional network server located in one of a plurality of regional mail facilities;
transmitting the electronic postmark from the regional network server to a general network server located in one of a plurality of general mail facilities; and
transmitting the electronic postmark from the general network server to one of a plurality of central databases;
wherein the general mail facilities are geographically dispersed throughout an area served by the communications network, each regional mail facility corresponds to discrete sections of the area served by the general mail facilities, and each mobile unit corresponds to a regional mail facility.

11. The method of claim 10, further comprising the step of
determining the origin of the mail piece when the mail piece is first picked up by a letter carrier; and
wherein the electronic postmark also includes the origin of the mail piece.

12. The method of claim 11, wherein the steps of transmitting the electronic postmark to the mobile communications device and transmitting the electronic postmark from the mobile communications device to the regional network server occur in substantially real-time.

13. The method of claim 12, wherein the plurality of general mail facilities are United States Postal Service General Mail Facilities, wherein the plurality of regional mail facilities are United States Post Offices, and wherein the one or more mobile units are United States Postal Service mail delivery vehicles.

14. The method of claim 12, further comprising the steps of:
determining the intended delivery location of the mail piece, the origin of the mail piece, and the current location of the mail piece when the mail piece arrives at the regional mail facility;
creating a second electronic postmark, wherein the second electronic postmark includes the intended delivery location of the mail piece, the origin of the mail piece, and the current location of the mail piece determined when the mail piece arrived at the regional mail facility;
transmitting the second electronic postmark from the regional network server to the general network server; and
transmitting the second electronic postmark from the general network server to one of the plurality of central databases.

15. The method of claim 14, further comprising the steps of:
determining the intended delivery location of the mail piece, the origin of the mail piece, and the current location of the mail piece when the mail piece arrives at the general mail facility;
creating a third electronic postmark, wherein the third electronic postmark includes the intended delivery location of the mail piece, the origin of the mail piece, and the current location of the mail piece determined when the mail piece arrived at the general mail facility; and
transmitting the third electronic postmark from the general network server to one of the plurality of central databases.
